(19) United States
(12) Patent Application Publication
(10) Pub. No.: US 2002/0044343 A1
(43) Pub. Date: Apr. 18, 2002

(54) Control system for optical amplifiers and optical fiber devices

(76) Inventor: Tariq Manzur, Lincoln, RI (US)

Correspondence Address: BARLOW, JOSEPHS & HOLMES, LTD., 101 DYER STREET, 5TH FLOOR, PROVIDENCE, RI, 02903, US

(21) Appl. No.: 09/907,305

(22) Filed: Jul. 17, 2001

Related U.S. Application Data
(60) Provisional application No. 60/218,588, filed on Jul. 17, 2000.

(51) Int. Cl. H01S 3/00

(52) U.S. Cl. 359/337.11

(57) ABSTRACT

An optical feedback control system utilizes one or more linear photodiode arrays to map the optical characteristics of an optical signal at a plurality of different wavelengths over an entire communication spectrum. The data gathered from the linear photodiode arrays is actively used to control gain and gain flatness of a fiber optic amplifier system or other optical fiber device, such as a fiber laser.

### BACKGROUND AND SUMMARY OF THE INVENTION

The instant invention relates to control systems for dynamically controlling gain and gain flatness in optical fiber devices, and more particularly to an optical feedback control system utilizing one or more linear photodiode arrays to map the optical characteristics of an optical signal at a plurality of different wavelengths over an entire communication spectrum. The data gathered from the linear photodiode arrays is actively used to control gain and gain flatness of a fiber optic amplifier system or other optical fiber device.

Most fiber optic amplifiers already utilize a control system for controlling average gain of the amplifier, and other parameters of operation. In the past, a portion of the transmission signal would be tapped off of the transmission line and fed to an individual photodiode to analyze a particular parameter of the signal. In other cases, the signal would be tapped at two separate points in the transmission line and fed to two photodiodes for comparison. One tap would be located before the amplifier block and the other tap after the amplifier block. The desired parameter measured from the two photodiodes, for example signal strength, would be compared and used to control laser diode power which, in turn, would allow control of average gain of the optical signal strength. The photodiodes provide a means for measuring what happens to the optical signal in the amplifier as changes are made and thus provide a means for controlling operation of the amplifier. The inherent limitation of simple photodiodes is that they can only be used to measure a single wavelength at a given time. While this was acceptable in older transmission systems where the usable wavelength band was fairly narrow, newer wavelength division multiplexed (WDM) transmission systems require a uniform gain profile over a far greater bandwidth so that each usable wavelength in the transmission spectrum is uniformly amplified. The use of conventional measurement and control systems has made monitoring and control of WDM transmission systems difficult.

As the industry seeks to expand the number of usable wavelengths in WDM transmission systems, the gain flatness of an optical amplifier across the entire transmission spectrum has become one of the most important characteristics of an amplifier, even more important than the overall gain. In this regard, other passive and active components, such as dynamic gain flattening filters (GFF's) and variable optical attenuators (VOA's), have been added to the amplifier systems to flatten the gain curve. However, even with these new devices, changing input signal strength and other variable factors in operation still make it difficult to dynamically control gain flatness over a broad spectrum of wavelengths.

Accordingly, while the existing control systems are effective to a limited extent, they do not provide the flexibility or spectral range required for a true dynamically controlled gain flattened amplifier system. There is thus a need in the industry to provide a control system that can actively measure the gain profile of the entire operating spectrum of the input signal so that the entire gain curve of the amplifier can be controlled more efficiently.

The instant invention provides a control system that employs at least one Linear Indium Gallium Arsenide Photodiode Array for monitoring the entire transmission spectrum and a microcontroller programmed with appropriate software, and control parameters for controlling the optical amplifier system. The microcontroller is connected to the diode laser pump(s) of the amplifier, active gain-flattening filters (GFF's) and the variable optical attenuators (VOA's). The transmission signal is tapped from the transmission line by an optical tap and fed to the linear photodiode array for analysis. The linear photodiode array is effective for analyzing the entire spectrum of the transmission signal. In basic terms, the photodiode array functions as a spectrum analyzer for analyzing the entire transmission system in an active control system. Based on information provided and the control parameters, the microprocessor can be programmed to control the laser diodes, filters and attenuators to control and flatten the output of the amplifier responsive to slight variations in the optical signal.

Accordingly, among the objects of the instant invention are: the provision of an improved means for analyzing the entire spectrum of an optical transmission signal from a single or multiple tap source(s); the provision of an improved control system which utilizes linear photodiode arrays to analyze the spectral characteristics of an optical transmission signal and which uses the information provided to control the various components of the amplifier system; the provision of such a control system wherein the optical signal is tapped at point that precede the amplifier, follow the amplifier and/or both; and the provision of such a control system which is effective for controlling the pump sources, gain flattening filters and variable optical attenuators of a complex optical amplifier system.

Other objects, features and advantages of the invention shall become apparent as the description thereof proceeds when considered in connection with the accompanying illustrative drawings.

### DESCRIPTION OF THE DRAWINGS

In the drawings which illustrate the best mode presently contemplated for carrying out the present invention:

FIG. 1 is a graphical illustration of average optical gain of an amplifier as measured by a conventional photodiode at a single wavelength;

FIG. 2 is a graphical illustration of an optical gain curve as measured by a linear photodiode array at multiple wavelengths, as part of the control system of the present invention;

FIG. 3 is a schematic illustration of a single-stage Erbium-doped fiber optic amplifier employing the control system of the present invention;

FIG. 4 is a schematic illustration of a dual-stage Erbium-doped fiber optic amplifier employing the control system of the present invention;

FIG. 5 is a schematic illustration of a fiber laser employing the control system of the present invention; and

FIG. 6 is a schematic illustration of a Raman fiber optic amplifier system employing the control system of the present invention.

### DESCRIPTION OF THE PREFERRED EMBODIMENT

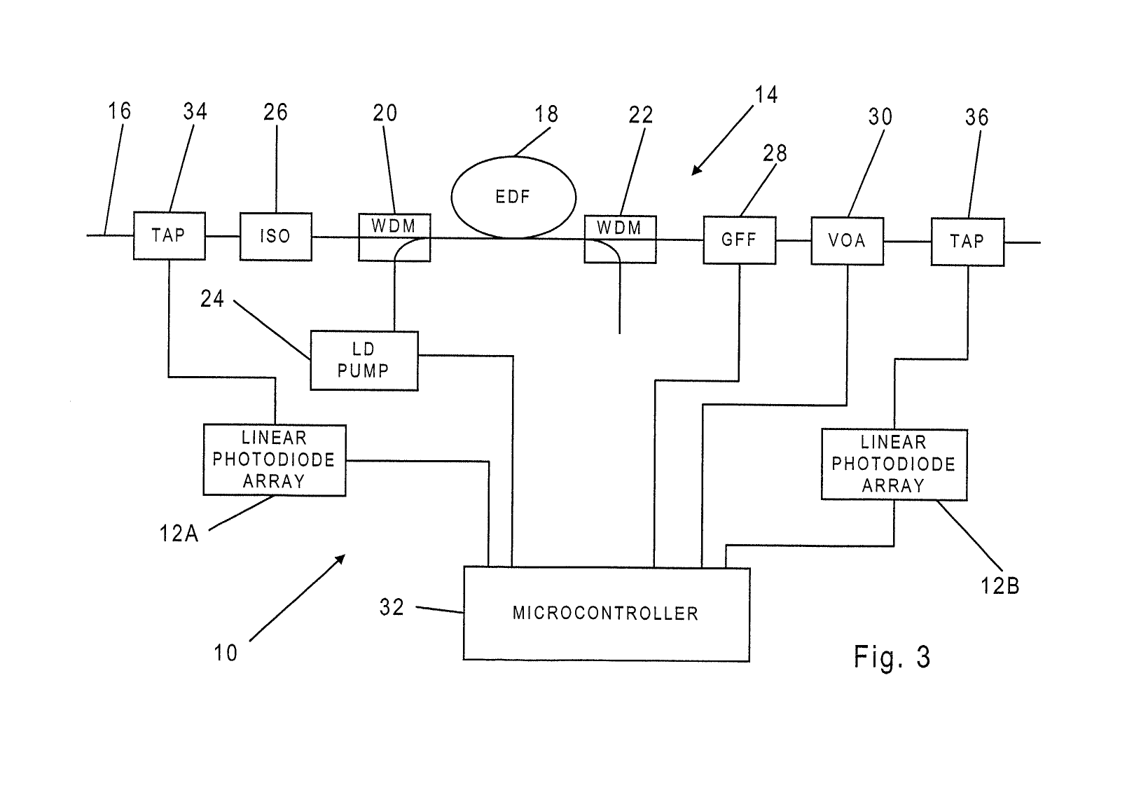

Referring now to the drawings, the optical device control systems of the instant invention are illustrated and generally indicated 10 in FIGS. 3-6.

As will hereinafter be more fully described, the instant control systems 10 utilize one or more linear photodiode arrays 12 to map the optical characteristics of an optical signal at a plurality of different wavelengths over an entire communication spectrum.

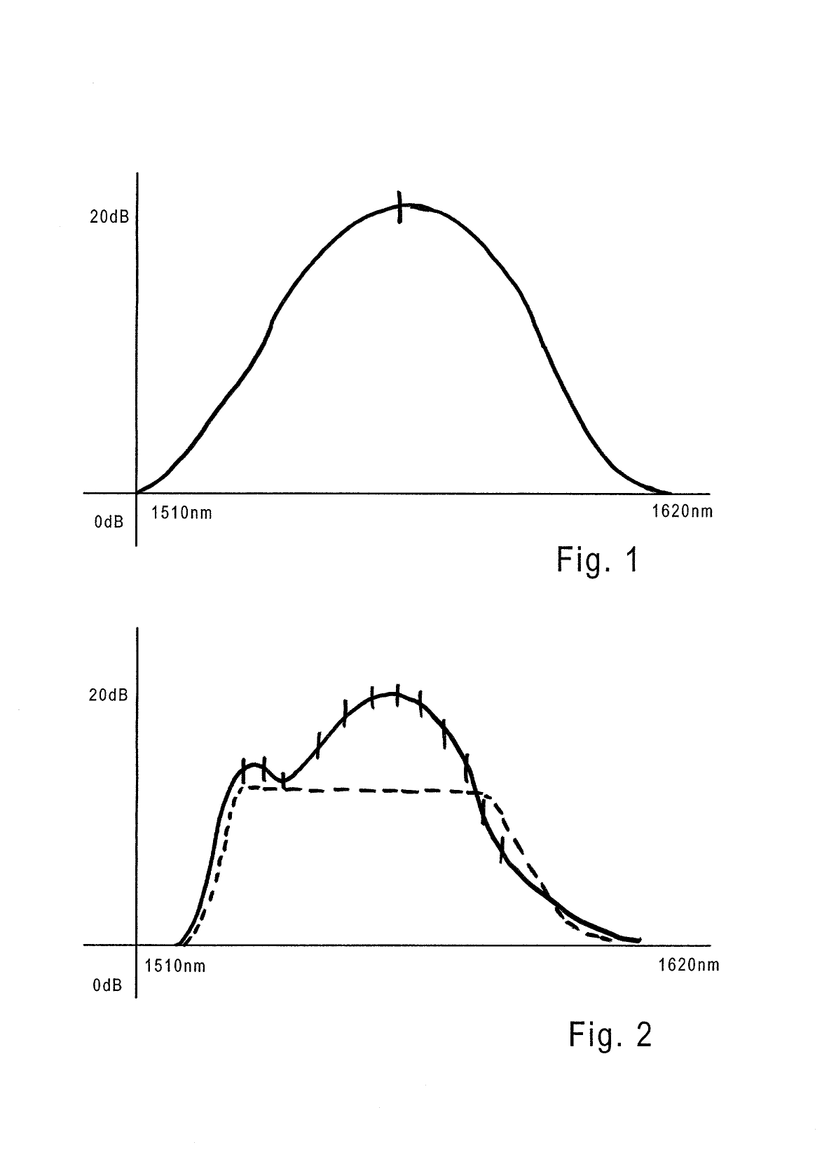

Referring to FIG. 1 of the drawings, there is shown a graphical illustration of the gain curve of an erbium-doped amplifier as measured by a prior art photodiode system. The prior art typically measured average gain of the amplifier by measuring the gain at a central wavelength in or about the middle of the amplified wavelength spectrum, i.e. in or about 1540 nm to about 1550 nm. The resulting graph is a bell-shaped curve that shows signal strength decreasing to each side of the central measured wavelength. While the single sampling of information from this wavelength was effective for determining the maximum gain of the amplifier at a central wavelength of the amplified spectrum, the actual shape of the gain curve at lower and higher wavelength is much more complex and is not accurately represented by a single sampling of data at a central wavelength. As the industry seeks to expand the number of usable wavelengths in WDM transmission systems, the gain flatness of an optical amplifier across the entire transmission spectrum has become one of the most important characteristics of an amplifier, even more important than the overall gain.

Referring to FIG. 2, there is shown a graphical illustration of the actual shape of the gain curve of the same erbium-doped amplifier as determined by a sampling of data from a plurality of wavelengths along the entire amplified spectrum. As can be seen from the graph, there is a slight hump at the lower end of the spectrum and the higher end of the spectrum drops off somewhat steeper than as represented by the average in FIG. 1. As indicated above, the industry has continually sought an amplifier that has a flat gain profile over the broadest possible wavelength band. By flat gain, we mean that the amplifier has a gain profile that has a relatively flat plateau of the same gain across a wide band. Such a curve is illustrated in broken line in FIG. 2. In this regard, other passive and active components, such as dynamic gain flattening filters (GFF's) and variable optical attenuators (VOA's), have been added to existing amplifier systems to flatten the gain curve to the greatest extent possible. However, even with these new devices, changing input signal strength and other variable factors in operation still make it difficult to dynamically control gain flatness over a broad spectrum of wavelengths. The data gathered from the linear photodiode arrays 12 as taught by the present invention, is actively used to control gain and gain flatness of a fiber optic amplifier system or other optical fiber device, such as a fiber laser.

It is pointed out that erbium doped fibers are described herein as representative examples and as part of the preferred embodiments. However, it should be understood that the principles and concepts herein are equally applicable to other amplifier systems and other optical devices using other types of rare-earth doped fibers and using Raman amplification effects.

Referring now to FIG. 3, a single-stage Erbium-doped fiber optic amplifier constructed in accordance with the teachings of the present invention is illustrated and generally indicated at 14. The amplifier 14 is spliced into a conventional optical transmission fiber 16 configured to propagate an optical transmission signal. The amplifier 14 includes a length of erbium doped fiber 18 that is spliced into the transmission fiber 16 using an input wavelength division multiplexer (WDM) coupler 20, and an output WDM coupler 22. The amplifier 14 is pumped by a laser diode pump laser 24 of appropriate wavelength and power to stimulate emissions of the erbium ions in the desired transmission wavelength range. The amplifier 14 further includes an optical isolator 26 preceding the input WDM coupler 20, a dynamic gain flattening filter (GFF) 28 following the output WDM coupler 22, and further includes a variable optical attenuator (VOA) 30 following the GFF 28. The optical isolator 26, GFF 28 and VOA 30 are conventional amplifier components that are commercially available from multiple sources. Accordingly, no further description or explanation of the function of these devices is believed to be necessary.

With regard to the control system 10 of the amplifier 14, the pump laser 24, GFF 28 and VOA 30 are each electronically connected to a microcontroller 32 which is programmed with appropriate software and control parameters to adjust and control these active components during operation. Microcontrollers and microprocessors of the type contemplated for use herein and the software for programming their operation are well known in the electronics arts. The control system 10 of the present invention is preferably based on a comparative analysis of information as taken from two separate points in the transmission fiber 16. Accordingly, the preferred embodiment as shown in FIG. 3 comprises first and second linear photodiode arrays 12A and 12B, such as the LX series—Linear Indium Gallium Arsenide Photodiode Array commercially available from Sensors Unlimited, Inc. On the input side of the amplifier 14, the input optical transmission signal is tapped from the transmission fiber 16 by an optical tap 34 and is provided to the first linear photodiode array 12A for analysis. On the output side of the amplifier 14, the amplified optical transmission signal is tapped from the transmission fiber 16 following the VOA 30 by a second optical tap coupler 36, and is provided to the second linear photodiode array 12B for analysis. The two linear photodiode arrays 12A and 12B are effective for analyzing the entire spectrum of the transmission signal and providing a comprehensive analysis of the actual shape of the gain curve at a given point in time. In more basic terms, the linear photodiode arrays 12A, 12B function as a spectrum analyzers for analyzing the entire transmission system in an active control system. Based on information provided and a comparison of the two gain profiles, the microcontroller 32 can more effectively control the laser diode 24, GFF 28 and VOA 30 to control the output of the amplifier 14. The use of two linear photodiode arrays 12A, 12B provides for comparison of signals at different stages of the amplifier 14 and thus leads to improved control.

In the present embodiment, the two linear photodiode arrays 12A, 12B are respectively located at positions preceding and following the active erbium fiber 18 of the amplifier 14. However, it is to be understood that the signal can be tapped anywhere in the transmission line 16, depending on the circumstances and design of the amplifier 14, and it is to be understood that a single linear photodiode array 12 could be used in a basic arrangement with similar effectiveness. In this regard, a single tap could be located preceding the erbium-doped fiber 18 or following the erbium-doped fiber 18.

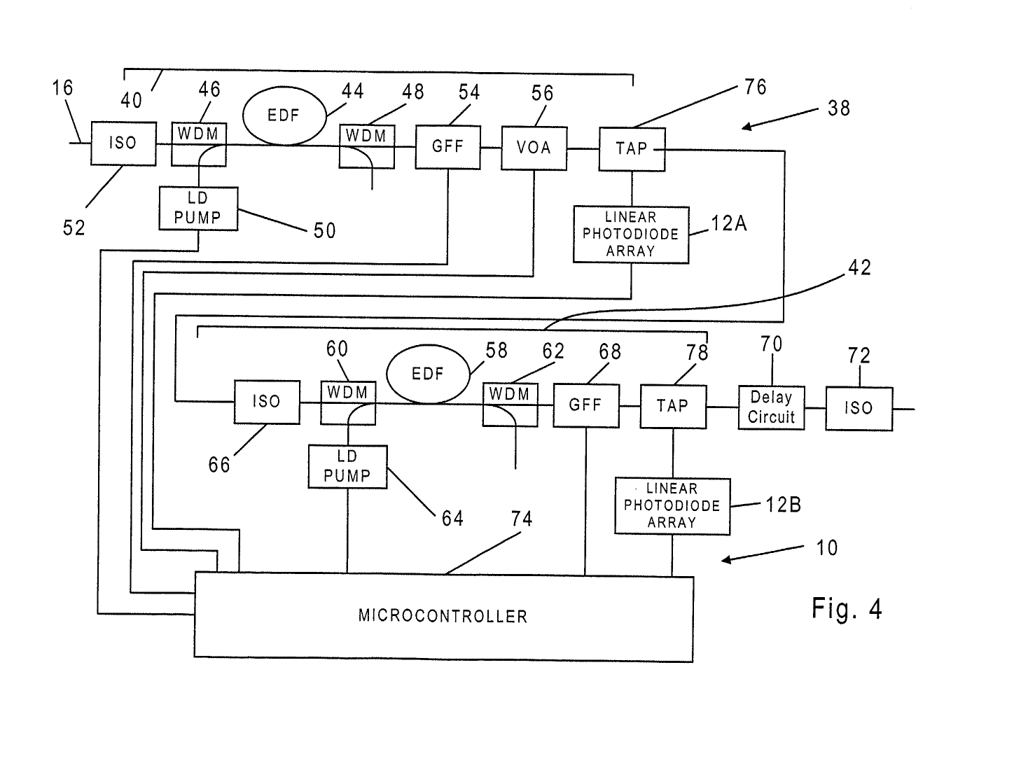

Referring now to FIG. 4, a dual-stage erbium-doped fiber optic amplifier constructed in accordance with the teachings of the present is illustrated and generally indicated at 38. The dual-stage amplifier 38 includes a first stage amplifier system generally indicated at 40 having the same general components as the single stage amplifier 14 as illustrated in FIG. 3, and further includes a second stage amplifier system generally indicated at 42 that also includes the same general set of component elements. More specifically, the first stage amplifier system 40 comprises a length of erbium-doped fiber 44 that is spliced into the transmission fiber 16 using an input wavelength division multiplexer (WDM) coupler 46, and an output WDM coupler 48. The first amplifier stage 38 is pumped by a laser diode pump laser 50 of appropriate wavelength and power to stimulate emissions of the erbium ions in the desired transmission wavelength range. The first amplifier stage 38 further includes an optical isolator 52 preceding the input WDM coupler46, a dynamic gain flattening filter (GFF) 54 following the output WDM coupler 48, and further includes a variable optical attenuator (VOA) 56 following the GFF. The second stage amplifier system 42 similarly comprises a length of erbium doped fiber 58 that is spliced into the transmission fiber 16 using an input wavelength division multiplexer (WDM) coupler 60, and an output WDM coupler 62. The second stage amplifier 42 is pumped by a laser diode pump laser 64 of appropriate wavelength and power to stimulate emissions of the erbium ions in the desired transmission wavelength range. The second stage amplifier 42 further includes an optical isolator 66 preceding the input WDM coupler 60, a dynamic gain flattening filter (GFF) 68 following the output WDM coupler 62, and further includes a delay circuit 70 and another optical isolator 72 following the GFF.

The pump lasers 50, 64, GFF's 54, 68 and VOA 56 are each electronically connected to a microcontroller 74 which is programmed with appropriate software and control parameters to adjust and control these active components during operation. The control system 10 further comprises first and second linear photodiode arrays 12A, 12B tapped into the transmission fiber 16 as previously described hereinabove using optical tap couplers 76, 78. The first photodiode array 12A is positioned between the VOA 56 on the output side of the first stage 40 and the optical isolator 66 on the input side of the second stage 42. On the output side of the amplifier 38, the amplified optical transmission signal is tapped from the transmission fiber 16 following the second GFF 68, and is provided to the second linear photodiode array 12B for analysis.

As in the single-stage amplifier system 14, the two linear photodiode arrays 12A, 12B are effective for analyzing the entire spectrum of the transmission signal and providing a comprehensive analysis of the actual shape of the gain curve at a given point in time. Based on information provided and a comparison of the two gain profiles, the microcontroller can more effectively control the laser diodes 50, 64, GFF's 54, 68 and VOA 56 to control the output of the amplifier stages 40, 42.

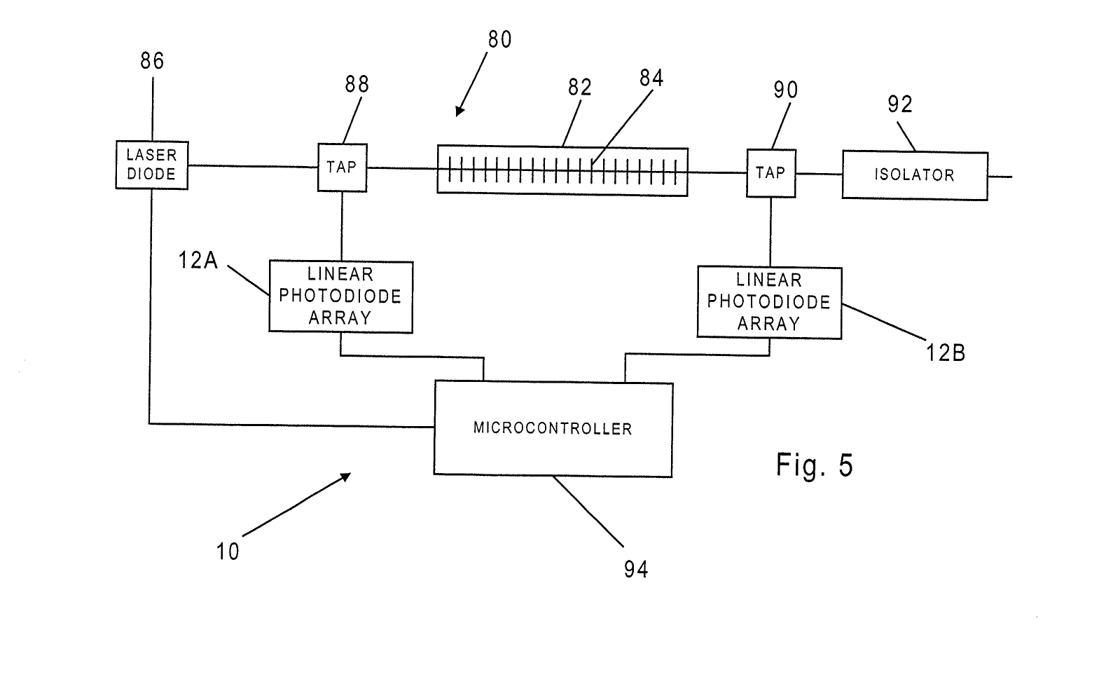

Turning now to FIG. 5, it is also to be understood that the present control system 10 could be used effectively for controlling the operation of a distributed feedback (DFB) fiber laser as well. In this regard, a fiber laser constructed in accordance with the teachings of the present invention is illustrated and generally indicated at 80 in FIG. 5. As will hereinafter be more fully described, the DFB fiber laser assembly 80 comprises a single mode, rare-earth doped optical fiber generally indicated at 82 having a Bragg grating 84, and a light source generally indicated at 86 coupled to the fiber 82.

The doped optical fiber 82 is well known in the fiber optic arts, and is available from any one of a variety of commercial sources. The fiber 82 is doped with a rare earth ion, such as erbium, to provide a stimulated light emission as pump light passes through the doped fiber 82. The fiber 82 is provided with a uniform Bragg grating 84. The creation of Bragg gratings in optical fibers is well known in the art, and will not be described further herein. The grating 84 is written into the fiber 82 so that the fiber 82 produces an output with a desired wavelength as is common in the art of DFB fiber lasers. It is desirable to keep the length of the fiber 82 short, and in this regard it is preferred that the length of the fiber 82 be limited to between about 2 cm to about 6 cm. Reflectivity of the grating 84 is generally determined by the lasing wavelength, the dopant level and the length of the fiber. The preferred fiber 82 should have a length between about 2 cm and about 6 cm, and have a reflectivity of about 90%.

The light source 86 comprises any known, or unknown, light source having an output wavelength within the rare-earth absorption spectrum. Such light sources include, but are not limited to semiconductor laser diodes, as well as other light sources. In keeping with the previously discussed erbium-doped fiber example, a representative light source comprises a 50 mW semiconductor laser diode having a 980 nm or 1480 nm wavelength output.

With regard to the control system 10, the optical signal is preferably tapped from the fiber laser construction at two points using optical tap couplers 88, 90, namely between the laser diode 86 and the input of doped fiber 82, and between the output of the doped fiber 82 and an optical isolator 92. The tap coupler output is provided to the linear photodiode arrays 12A, 12B as described above. The laser source 86 and the photodiode arrays 12 are connected to a microcontroller 94 as described above. Based on information provided and a comparison of the two gain profiles, the microcontroller 94 can more effectively control the laser diode 86 to control the output of the fiber laser 80.

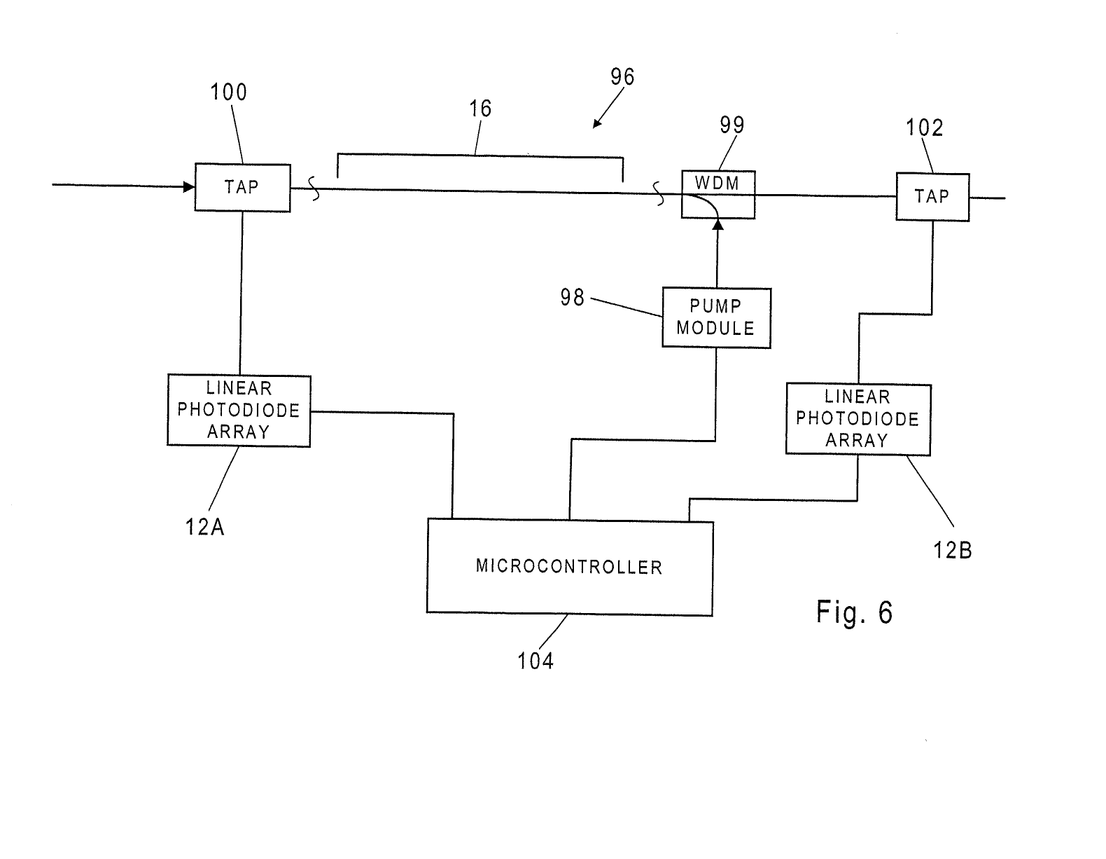

Even further still, referring to FIG. 6, the control system of the present invention is applicable for use in a Raman amplifier. In this regard, a Raman amplifier constructed in accordance with the teachings of the present invention is illustrated and generally indicated at 96 in FIG. 6. A typical Raman amplifier 96 comprises a an optical transmission fiber 16 configured to have an optical signal propagate therethrough, a backward pumping module 98 configured to pump light into the optical transmission fiber 16 and a WDM optical coupler 99 that optically interconnects the pump module 98 with the transmission fiber 16. The optical signal is preferably tapped from the transmission fiber 16 at two points. A first tap coupler 100 is located at the input of transmission fiber 16, and a second tap coupler 102 is located at the output of the WDM coupler 98. The pump module 98, and linear photodiode arrays 12A, 12B are connected to a microcontroller as described hereinabove. Based on information provided and a comparison of the two signal profiles, the controller can more effectively control the laser diode pump module, individual laser diodes, filters, attenuators, etc. to control the output and operation of the amplifier system.

It can therefore be seen that the present invention provides a unique and novel control arrangement for controlling the operation of a variety of optical fiber devices. The linear photodiode arrays 12 as used in the present systems provide improved data and analysis of the input signal profile and gain profile of the amplifier systems over the entire communication spectrum rather than a single operating wavelength. These linear photodiode arrays 12 are operable in real time and can provide a real time analysis of the operation of an amplifier system allowing real-time adjustment of operating parameters in order to quickly control and compensate for fluctuating input signals and other variable factors during operation. For these reasons, the instant invention is believed to represent a significant advancement in the art which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. An optical amplifier system comprising:
an optical transmission fiber configured to have a WDM optical transmission signal propagate therethrough,
a rare-earth doped fiber optic amplifier configured to amplify said transmission signal, said amplifier including a pump source;
an optical tap configured to extract a portion of said transmission signal;
a linear photodiode array configured to receive said extracted portion of said transmission signal, said linear photodiode array detecting an optical characteristic of said transmission signal at a plurality of wavelengths; and
a controller configured to control said pump source to flatten a gain profile of said optical amplifier system responsive to an output received from said linear photodiode array.

2. The optical amplifier system of claim 1 wherein said optical tap coupler precedes said amplifier.

3. The optical amplifier system of claim 1 wherein said optical tap coupler follows said amplifier.

4. The optical amplifier system of claim 1 further comprising a dynamic gain flattening filter (GFF) following said amplifier, said controller being configured to control said pump source and said GFF responsive to said output received from said linear photodiode array.

5. The optical amplifier system of claim 1 further comprising a variable optical attenuator (VOA) following said amplifier, said controller being configured to control said pump source and said VOA responsive to said output received from said linear photodiode array.

6. The optical amplifier system of claim 4 further comprising a variable optical attenuator (VOA) following said amplifier, said controller being configured to control said pump source, said GFF and said VOA responsive to output received from said linear photodiode array.

7. The optical amplifier system of claim 2 further comprising a second optical tap following said amplifier and configured to extract a portion of said amplified transmission signal; and
a second linear photodiode array configured to receive said extracted portion of said amplified transmission signal, said linear photodiode array detecting an optical characteristic of said amplified transmission signal at a plurality of wavelengths of said transmission signal,
wherein said controller is configured to control said pump source to flatten a gain profile of said optical amplifier system responsive to outputs received from said linear photodiode arrays.

8. The optical amplifier system of claim 7 further comprising a dynamic gain flattening filter (GFF) following said amplifier, said controller being configured to control said pump source and said GFF responsive to said outputs received from said linear photodiode arrays.

9. The optical amplifier system of claim 7 further comprising a variable optical attenuator (VOA) following said amplifier, said controller being configured to control said pump source and said VOA responsive to said outputs received from said linear photodiode arrays.

10. The optical amplifier system of claim 8 further comprising a variable optical attenuator (VOA) following said amplifier, said controller being configured to control said pump source, said GFF and said VOA responsive to said outputs received from said linear photodiode arrays.

11. A dual-stage optical amplifier system comprising:
an optical transmission fiber configured to have a WDM optical transmission signal propagate therethrough,
a first rare-earth doped fiber optic amplifier configured to amplify said transmission signal, said first amplifier including a first pump source;
a second rare-earth doped fiber optic amplifier configured to further amplify said transmission signal, said second amplifier including a second pump source;
a first optical tap following said first amplifier and preceding said second amplifier configured to extract a portion of said transmission signal;
a first linear photodiode array configured tp receive said extracted portion of said transmission signal, said first linear photodiode array detecting an optical characteristic of said transmission signal at a plurality of wavelengths;
a controller configured to control said first and second pump sources to flatten a gain profile of said dual-stage optical amplifier system responsive to outputs received from said first and second linear photodiode arrays.

12. The dual-stage optical amplifier system of claim 11 further comprising a second optical tap coupler following said second amplifier and configured to extract a second portion of said transmission signal and a second linear photodiode array configured to receive said second extracted portion of said transmission signal, said second linear photodiode array detecting an optical characteristic of said transmission signal at a plurality of wavelengths of said transmission signal, wherein said controller is configured to control said first and second pump sources to flatten a gain profile of said dual-stage optical amplifier system responsive to said outputs received from said linear photodiode arrays.

13. The dual-stage optical amplifier system of claim 11 further comprising a first dynamic gain flattening filter (GFF) following said first amplifier and preceding said second amplifier, said controller being configured to control said pump sources and said GFF responsive to said output received from said linear photodiode array.

14. The dual-stage optical amplifier system of claim 11 further comprising a variable optical attenuator (VOA) following said first amplifier and preceding said second amplifier, said controller being configured to control said pump sources and said VOA responsive to said output received from said linear photodiode array.

15. The dual-stage optical amplifier system of claim 13 further comprising a variable optical attenuator (VOA) following said first amplifier and preceding said second amplifier, said controller being configured to control said pump source, said GFF and said VOA responsive to output received from said linear photodiode array.

16. The dual-stage optical amplifier system of claim 13 further comprising a second dynamic gain flattening filter (GFF) following said second amplifier, said controller being configured to control said pump sources and said GFF's responsive to said output received from said linear photodiode array.

17. The dual-stage optical amplifier system of claim 16 further comprising a variable optical attenuator (VOA) following said first amplifier and preceding said second amplifier, said controller being configured to control said pump source, said GFF's and said VOA responsive to output received from said linear photodiode array.

18. The dual-stage optical amplifier system of claim 12 further comprising a first dynamic gain flattening filter (GFF) following said first amplifier and preceding said second amplifier, said controller being configured to control said pump sources and said GFF responsive to outputs received from said linear photodiode arrays.

19. The dual-stage optical amplifier system of claim 12 further comprising a variable optical attenuator (VOA) following said first amplifier and preceding said second amplifier, said controller being configured to control said pump sources and said VOA responsive to outputs received from said linear photodiode arrays.

20. The dual-stage optical amplifier system of claim 18 further comprising a variable optical attenuator (VOA) following said first amplifier and preceding said second amplifier, said controller being configured to control said pump source, said GFF and said VOA responsive to outputs received from said linear photodiode arrays.

21. The dual-stage optical amplifier system of claim 18 further comprising a second dynamic gain flattening filter (GFF) following said second amplifier, said controller being configured to control said pump sources and said GFF's responsive to outputs received from said linear photodiode arrays.

22. The dual-stage optical amplifier system of claim 12 further comprising a variable optical attenuator (VOA) following said first amplifier and preceding said second amplifier, said controller being configured to control said pump source, said GFF's and said VOA responsive to outputs received from said linear photodiode arrays.

23. A distributed feedback fiber laser assembly comprising:
a rare-earth doped optical fiber having a grating;
a pump source configured to pump light into said doped optical fiber and stimulate emissions from said doped optical fiber;
an optical tap configured to extract a portion of said pump light;
a linear photodiode array configured to receive said extracted portion of'said pump light, said linear photodiode array detecting an optical characteristic of said pump light at a plurality of wavelengths; and
a controller configured to control said pump source to control an output profile of said fiber laser responsive to an output received from said linear photodiode array.

24. The fiber laser of claim 23 further comprising a second optical tap following said doped optical fiber and configured to extract a portion of said stimulated emissions from said optical fiber, and a second linear photodiode array configured to receive said extracted portion of said stimulated emissions, said second linear photodiode array detecting an optical characteristic of said stimulated emissions at a plurality of wavelengths of said transmission signal,
wherein said controller is configured to control said pump source to control an output profile of said fiber laser responsive to outputs received from said first and second linear photodiode arrays.

25. A Raman amplifier system comprising:
an optical fiber configured to have an optical signal propagate therethrough;
a pump source configured to pump light into said optical fiber and Raman-amplify with said pump light said optical signal;
an optical tap configured to extract a portion of said optical signal;
a linear photodiode array configured to receive said extracted portion of said optical signal, said linear photodiode array detecting an optical characteristic of said optical signal at a plurality of wavelengths; and
a controller configured to control said pump source to flatten a gain profile of said optical amplifier system responsive to an output received from said linear photodiode array.

26. The Raman amplifier system of claim 25 wherein said optical tap precedes an input of said optical fiber.

27. The Raman amplifier system of claim 25 wherein said optical tap follows an output of said optical fiber.

28. The Raman amplifier system of claim 26 further comprising a second optical tap following an output of said optical fiber and configured to extract a portion of said amplified optical signal, and a second linear photodiode array configured to receive said extracted portion of said amplified optical signal, said second linear photodiode array detecting an optical characteristic of said amplified optical signal at a plurality of wavelengths of said optical signal, wherein said controller is configured to control said pump source to control an output profile of said Raman amplifier system responsive to outputs received from said first and second linear photodiode arrays.

29. A method of controlling an optical device having an optical fiber configured to propagate an optical signal and further having at least one adjustable optical component, said method comprising the steps of:
extracting a portion of said optical signal from said optical fiber;
providing said extracted portion of said optical signal to a linear photodiode array;
determining an optical characteristic of said optical signal at each of a plurality of different wavelengths using said linear photodiode array;
controlling said at least one adjustable optical component responsive to said optical characteristic of said optical signal as determined by said linear photodiode array.

30. The method of claim 29 wherein said at least one adjustable optical component is selected from the group consisting of: a pump source, an active gain flattening filter, and a variable optical attenuator.

31. A method of controlling an optical amplifier system having an optical fiber configured to propagate an optical signal and an amplifier configured to amplify said optical signal, said amplifier further having a pump source, said method comprising the steps of:
extracting a first portion of said optical signal from said optical fiber at a location preceding said amplifier;
extracting a second portion of said optical signal from said optical fiber at a location following said amplifier;
providing said first extracted portion of said optical signal to a first linear photodiode array;
providing said second extracted portion of said optical signal to a second linear photodiode array;
determining an optical characteristic of said first and second portions of said optical signals at each of a plurality of different wavelengths using said first and second linear photodiode arrays;
controlling said pump source responsive to said optical characteristics of said optical signals as determined by said linear photodiode arrays.
